(19) United States
(12) Patent Application Publication
(10) Pub. No.: US 2020/0077604 A1
(43) Pub. Date: Mar. 12, 2020

(54) METHOD FOR OBTAINING A GROWTH MEDIUM FOR GROWING PLANTS, THE GROWTH METHOD AND THE INTERMEDIATE MIXTURE OF THE HOMOGENEOUS MATERIAL AND INCERATION ASH FOR INPLEMENTING THE METHOD FOR OBTAINING THE MEDIUM

(71) Applicant: SOUS LES FRAISES SAS, Paris (FR)

(72) Inventor: Yohan HUBERT, Paris (FR)

(73) Assignee: SOUS LES FRAISES SAS, Paris (FR)

(21) Appl. No.: 15/750,649

(22) PCT Filed: Aug. 4, 2016
(86) PCT No.: PCT/EP2016/068630

§ 371 Date: Feb. 6, 2018

(51) Int. Cl. A01G 24/22; A01C 3/00; C05D 9/00; C05F 11/08

(52) U.S. Cl. CPC A01G 24/22; C05F 11/08; C05D 9/00; A01C 3/00

(57) ABSTRACT

Method for obtaining a growth medium for growing plants comprising taking organic waste suitable to the plants to be grown, mixing it to obtain a homogeneous material and reducing its microbial activity, incinerating organic waste suitable to the plants to be grown to obtain ash, a source of minerals suitable for the cultivation of said plants, and incubating the homogeneous material with the ash to restart the microbial activity, initiating the mineralization of the material, and obtaining a ready-to-use growth medium.

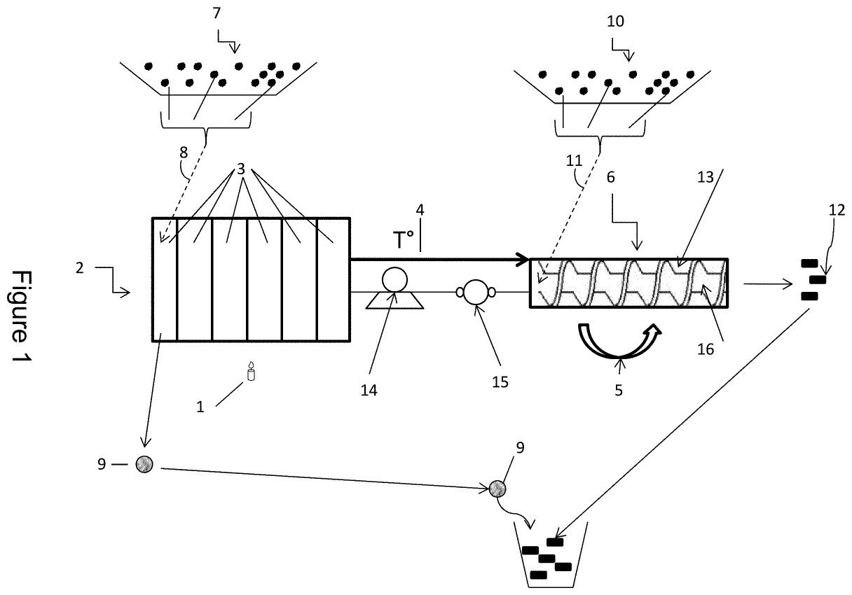

### TECHNICAL FIELD OF THE INVENTION

The present invention relates to growing plants on a growth medium, in particular on a medium obtained by mixing organic waste further fertilized with ash from organic waste.

### PRIOR ART

Growing plants on growth medium has already been attempted. However, several limitations present a barrier to the expansion of this type of cultivation.

First of all, the use of a growth medium entails the risk that such medium will decay.

In addition, the match between the minerals contained in such growth medium and the requirements of the plant grown is rarely perfect. Moreover, the nutrient requirements of the plant vary during the development thereof (germination—growth—fruiting), so that it is impossible to make the availability of these minerals, released from the growth medium, coincide over time with the requirements of the plant grown.

The presence of microorganisms must also be monitored: if they are too abundant, they accelerate the decay, whereas the absence thereof prevents the release of minerals from the medium or any symbiotic activity at the level of the roots. Some microorganisms protect plants by preventing other more harmful microorganisms from colonizing a free space.

The present invention aims to overcome all these drawbacks.

To this end, the present invention relates first of all to a method for obtaining a growth medium for growing plants, characterized in that organic waste suitable for growing the plants is used; it is mixed to obtain a homogeneous material and to reduce its microbial activity;

organic waste suitable for growing the plants is incinerated to obtain ash, a source of minerals suitable for growing said plants, and

said homogeneous material is incubated with said ash to restart said microbial activity and to initiate the mineralization of said material and to obtain a ready-to-use growth medium.

Preferably, the incubation step is carried out at controlled humidity (e.g. 50-80%, preferably about 60%).

The growth medium of the present invention may further contain microorganisms, such as microorganisms capable of releasing minerals from this growth medium and/or microorganisms capable of promoting the growth of the plant, for example by establishing associations and/or symbioses at the root level of the plants. These microorganisms will advantageously be introduced during the incubation step of the growth medium.

Such method makes it possible to prepare all the ingredients for a medium for growing plants and preserving the ingredients over time.

When necessary, the medium is quickly reactivated. Furthermore, the method of the invention allows a better match between the needs of the plants to be grown and the availability of the minerals present in the medium, i.e. the minerals of the mixed material and the minerals of the incinerated material, especially when the needs of the plants change over time.

An advantage of the present invention is that it makes it possible to reduce the volume of the waste and to enhance its contribution to the environment in a positive way, while allowing optimal growth of the plants cultivated.

Advantageously, the organic waste for the growth medium is sorted, selected and/or chosen according to the content in minerals thereof chosen from potassium, nitrogen, phosphorus, iron and magnesium.

Thus, organic waste of multiple origins (of plants) may be mixed together, so as to produce a growth medium having a content of these minerals that complies with the requirements of the plant to be grown

Preferably, the mixed organic material is packaged in the form of pellets.

Alternatively, it may be packaged in bulk. Advantageously, the mixed organic material has a reduced moisture content, for example a moisture content of less than 30% (weight in water over total weight), or less than 20% and even 10% or less.

In addition to the effect of mixing to reduce the activity of microorganisms, the packaging may advantageously reduce the activity of microorganisms. Thus, and by way of example, the packaging may be impermeable to gases and/or moisture, which makes it possible to maintain a low level of moisture in the mixed organic matter or to slow down any activity of the microorganisms, particularly because of a reduced oxygen content.

The organic waste for mixing may be different than that for incineration. For example, the organic waste for mixing will advantageously be devoid of waste of animal origin, whereas the organic waste for incineration may contain waste of animal origin, when ash enriched in phosphorus, or even nitrogen, is desired.

The waste (“plant” and preferably also “animal”) to be incinerated is sorted, selected and/or chosen according to its content in minerals from the group including potassium, nitrogen, phosphorus, iron and magnesium. Thus, organic waste from multiple origins (plants and preferably also animals) may be sorted by class according to its mineral content (K, Fe, Mg, P, N), then incinerated together so as to produce ash having a content of these minerals which complies with the requirements of the plant to be grown, the mineral content of this ash for growing plants may vary according to the stage of development of such plants. Thus, the growth medium for growing plants according to the invention may contain a first type of ash, then be further enriched by the addition of a second type of ash. Thus, ash rich in phosphorus may be obtained from organic matter comprising animal waste and will be suitable for a growth medium for promoting the germination of the plants to be grown.

Still more advantageously, the incineration of different classes of waste may be carried out at the same time in a compartmentalized furnace where each class occupies a different compartment.

The energy released during incineration may be used during the mixing step, i.e., a part or all of the energy required for mixing comes from the energy released during waste incineration. In particular, the heat produced by incineration may be used for heating the mass to be mixed. This heat may also be used for driving a turbine and a motor operating the mixing unit.

Another aspect of the present invention relates to an apparatus for the combined production of the homogeneous material with reduced microbial activity and the ash comprising an organic waste mixing unit and a differentiated furnace comprising a combustion ignition burner and a plurality of compartments for receiving the classes of organic waste to incinerate, equipment wherein the energy produced by the combustion of organic waste (from plants and possibly animals) is used for heating the mixing unit. This heat may also be used for driving a turbine and a motor operating the mixing unit.

One aspect of the present invention relates to an intermediate mixture for implementing the method of the invention of a homogeneous material with reduced microbial activity obtained by mixing organic waste suitable for the plants to be grown and ash from the incineration of organic waste for growing such plants.

This mixture is obtained by the method for obtaining the medium of the invention.

This mixture may further contain microorganisms in addition to those present in the homogeneous material with reduced microbial activity. These additional microorganisms are chosen for their effect on plant growth.

According to a variant of the mixture, the homogeneous material with reduced microbial activity suitable for growing plants is packaged separately from the ashes for growing such plants and, if there are any, also separate from additional microorganisms.

Both the homogeneous material with reduced microbial activity suitable for the plants to be grown and ash for the growth of these plants are sorted and packaged to allow the efficient cultivation of these plants.

The invention of the present application also relates to a method of growing plants on a growth medium wherein one takes a mixture (i) of a homogeneous material with reduced microbial activity obtained by mixing organic waste adapted to the plants to be grown and (ii) ash from the incineration of organic waste for growing such plants; the material of the mixture is incubated to restart the microbial activity, to initiate the mineralization of said material, and to obtain a ready-to-use growth medium; and the plants to be grown are planted in said material.

Advantageously, additional microorganisms may be added.

Preferably, ash from incinerating organic waste for growing such plants that is higher in phosphorus is used during the initiation of the growth of these plants, for example to promote germination, and ash richer in iron or potassium is added during fruiting of the plants cultivated.

The invention will be better understood on reading the following description, with reference to the appended figure, which shows schematically the apparatus for obtaining the plant medium.

### DETAILED DESCRIPTION OF THE INVENTION

Organic wastes 7 and 10 are recovered and then sorted into classes according to the abundance in minerals (weight of the mineral with respect to the dry weight of the organic waste). For example, waste that is rich in iron, but has an intermediate content of potassium, phosphorus and nitrogen, or waste rich in phosphorus, but having an intermediate content of potassium, iron and nitrogen, will represent two distinct classes. The person skilled in the art knows well the mineral content of various organic compounds from plants or animals and is therefore able to select and assemble them into classes according to the requirements of the plants to be grown. Here, the organic waste 7 is sorted into a class 8, relatively rich in potassium, including tomatoes, zucchini and peppers. Other classes may be obtained from legumes (rich in nitrogen), cabbage (rich in iron), or waste from green areas (less rich in minerals) and mixtures thereof.

The organic wastes 7 and 10, and the sorted classes 8 and 11 may be either identical, depending on whether the waste is intended for incineration in a furnace 2 or mixed in a mixing unit (mixer) 6, or different. Here, the waste from tomatoes, zucchini and peppers to be incinerated is enriched with fish bones and bone marrow. Thus, these two classes 8 and 11 partially overlap.

It is therefore again provided that these wastes are different, the waste 10, intended for mixing, being exclusively from plants, whereas the waste 7, intended for incineration, or at least those of certain classes 8 which are derived therefrom, contain animal waste, richer in phosphorus.

The waste classes 8 intended for incineration are distributed here in the various compartments 3 of the furnace 2 to produce various classes of ash; here a class 9 is illustrated, for example, one resulting from waste from tomatoes, zucchini, peppers, fish bones and other bones. It should be noted that the furnace could comprise only one compartment, for the incineration of one class at a time.

A burner 1 initiates the combustion and the heat generated by the incineration of the waste is used here to (i) cause a moderate heating 4 of the mixer 6, which allows the waste to be partially dehydrated during mixing and (ii) to control the drive 5 of the mixing member 13 of the mixer 6. To this end, a turbine 14 and a motor 15 are mounted between the furnace 2 and the mixer 6, mounted here on the shaft 16 of the mixing member 13, here a screw.

A waste class 11 intended for mixing is mixed so as to reduce the activity of the microorganisms. Here, pellets 12 are obtained. This simplifies the logistics, allows a better control of the residual water content, and hence an effective reduction of microorganism activity. The products coming from the mixer 6 may be prepared in other forms, such as granules or an amorphous powder, provided that the activity of the microorganisms is reduced therein.

This may be achieved through proper packaging, for example, impervious to water to prevent rehydration or atmospheric gases and enclosing an inert atmosphere, to inhibit the metabolism of these microorganisms.

When the growth medium is to be used, the pellets 12 are incubated, here in the presence of water and a class of ash 9 from incineration. The activity of the microorganisms that were present resumes. The microorganisms multiply and initiate the mineralization of the pellets 12. It is also possible to add exogenous microorganisms to those present in the mixed material, for example microorganisms which will have a positive effect on the plant growth, such as microorganisms establishing symbiosis in the roots of the plant.

The “growth medium” of the present application may be defined as an organic material which has been mixed and which has a porosity suitable for the development of the roots of the plants to be grown. This growth medium must be incubated in order to restart the activity of the microorganisms present, here also with water, ashes resulting from incineration and exogenous microorganisms.

As for the adaptation of organic waste to the plants to be grown, reference is made to organic waste sorted according to the nutritional requirements of the plants to be grown; it is possible that one type of waste, taken in isolation, is not suitable to the plants' growth, but a mixture of waste containing this unsuitable waste is well suited. Thus, the product obtained during mixing will have a mineral content which will be determined according to the normal needs of the plants to be grown, depending on the variety to be grown, while the incineration ash will have a mineral content that may vary to some extent, for example to meet the increased needs of plants during critical phases of their development, such as germination or fruiting. Part of the organic waste may be of the same species as that of the plants to be grown.

Even if the ashes suitable for the plants' growth may, to a certain extent, compensate for a mineral content of the product obtained during mixing which is slightly insufficient, the applicant has noticed that a culture on a medium lacking in minerals was poorly compensated by the addition of ash, while the total omission of ash for the benefit of a culture on a finely selected growth medium resulted in a sharp loss of productivity of the culture. Thus, according to the present invention, both the product resulting from mixing and the ash must be suitable for the plants' growth.

Mixing results in a product with reduced microbial activity that is homogeneous, i.e. to say that different biological wastes can no longer be identified or isolated at the end of the mixing step.

The “reduced microbial” activity is that of a composition wherein either the capacity of the microorganisms to multiply, or their capacity to break down biomolecules, or their ability to release mineral elements from the mixed material, is reduced. For the “activity” to be “reduced”, at least one of the above three parameters must be reduced by at least 50%, preferably at least 75%, and even at least 90%.

The reduction of microbial activity provides a liquid, loaded with mineral salts and water, which may be used later to rebalance the nutrient requirements of the plants according to the stage of their growth and the activity of microorganisms.

The microbial activity is first reduced because of the mixing step, then restarted, which means that the microbial activity present in the material that is mixed and then incubated is greater than that present in the organic material after only the mixing step. Thus, the incubated material will advantageously have at least 75%, preferably at least 80%, or even at least 90% of the initial microbial activity, this parameter being preferably obtained without the addition of exogenous microorganisms.

1. Method for obtaining a growth medium for growing plants characterized in that one takes organic waste of plants selected as a function of their content in minerals in order to be adapted to the plants to be grown;
it is mixed to obtain a homogeneous material and to reduce its microbial activity;
the organic waste suitable to the plants to be grown is incinerated to obtain ash, a source of minerals adapted to the cultivation of said plants and
said homogeneous material is incubated with said ash to restart said microbial activity, to initiate the mineralization of said material, and to obtain a ready-to-use growth medium.

2. Method according to claim 1, wherein the mixed waste and the incinerated waste are different.

3. Method of claim 2, wherein the incinerated waste contains animal waste.

4. Method according to claim 1, wherein said material is incubated with symbiotic microorganisms of the plants to be grown.

5. Method according to claim 1, wherein the organic waste is mixed to obtain pellets.

6. Method according to claim 1, wherein the mixing energy is produced by incineration.

7. Intermediate mixture for the implementation of the method of claim 1, of a homogeneous material with reduced microbial activity obtained by mixing organic waste of plants selected as a function of their content in minerals in order to be suitable to the plants to be grown and ash from the incineration of organic waste suitable to said plants.

8. Mixture according to claim 7, wherein the mixed waste and the incinerated waste are different.

9. Mixture according to claim 8, wherein the incinerated waste contains animal waste.

10. Mixture according to claim 7, wherein said material is incubated with symbiotic microorganisms of the plants to be grown.

11. Mixture according to claim 7, wherein the organic waste is in the form of pellets or in bulk in a sealed package.

12. Method for growing plants on a growth medium characterized in that:
one takes the mixture of claim 7,
the material of the mixture is incubated to restart the microbial activity, to initiate the mineralization of said material, and to obtain a ready-to-use growth medium and
the plants to be grown are planted in said material.
